(19) United States
(12) Patent Application Publication
(10) Pub. No.: US 2021/0264073 A1
(43) Pub. Date: Aug. 26, 2021

(54) EVALUATION METHOD FOR THE USAGE EFFECTIVENESS OF THERMAL BARRIER COATING FOR TURBINE BLADE

(71) Applicant: XIANGTAN UNIVERSITY, Xiangtan, Hunan (CN)

(72) Inventors: Li YANG, Xiangtan, Hunan (CN); Zhiyuan LIU, Xiangtan, Hunan (CN); Yichun ZHOU, Xiangtan, Hunan (CN); Wang ZHU, Xiangtan, Hunan (CN)

(73) Assignee: XIANGTAN UNIVERSITY, Xiangtan, Hunan (CN)

(21) Appl. No.: 17/260,571

(22) PCT Filed: Dec. 6, 2019
(86) PCT No.: PCT/CN2019/123638

§ 371 Date: Jan. 15, 2021

(30) Foreign Application Priority Data
Oct. 9, 2018 (CN) 201811173708.1

(51) Int. Cl. G06F 30/17; G06F 30/23

(52) U.S. Cl. CPC G06F 30/17; G06F 2111/10; G06F 30/23

(57) ABSTRACT

A method for evaluating an application effect of a thermal barrier coating for a turbine vane comprises: performing a preset program for calculation according to distribution of temperature fields of two computational domains for the thermal barrier coating and the turbine vane without the thermal barrier coating as well as maximum principal stress and maximum shear stress data of a stress field of the thermal barrier coating to obtain heat insulation efficiency of the thermal barrier coating, so as to obtain a local comprehensive evaluation factor and a global comprehensive evaluation factor of the thermal barrier coating. In the present invention, a simulation method of the thermal barrier coating for the three-dimensional turbine vane having a gas film hole is realized; and an evaluation parameter for the application effect of the thermal barrier coating is established.

### TECHNICAL FIELD

The present invention relates to the technical field of heat-insulating protective coating systems in high-performance aero engines, and more particularly, to a method for evaluating an application effect of a thermal barrier coating for a turbine vane.

### BACKGROUND

As ceramic coatings, thermal barrier coatings (TBCs) are deposited on surfaces of high-temperature-resistant metals or super alloys. The thermal barrier coating can reduce a temperature of a base owning to its role of heat insulation for the material of the base to enable an engine turbine vane to operate at a high temperature, and has characteristics of a high melting point, a low thermal conductivity, corrosion resistance, and thermal shock resistance. During a high-temperature service, the thermal barrier coating can protect the base from the high temperature, improves a temperature and thermal efficiency of a heat engine, and thus is widely applied to the fields of aviation, chemical engineering, metallurgy and energy.

The thermal barrier coating is mainly applied to a complex vane with a gas film cooling structure and an internal cooling structure, and is complex and changeable in heat insulation performance. At present, it is a hot spot for studying the improvement of heat insulation efficiency of the thermal barrier coating to reduce the base temperature by improving compositions and a structure of the thermal barrier coating. In addition, as the thermal barrier coating may peel off and thus fails to perform its function in an application process under an adverse service environment, the vane base is exposed to a high-temperature gas, resulting in huge losses and disasters. Therefore, the service life is another key problem that restricts the application and development of the thermal barrier coating.

As two very important parameters of the thermal barrier coating, the heat insulation performance and the service life have been studied and predicted extensively, and stress is the most important factor affecting the service life. However, the thermal barrier coating may have good heat insulation performance but a shorter service life when the stress is higher, or may cause premature failure of the base vane arising from poorer heat insulation performance when the stress is lower under different working conditions due to the complex structure of the vane. As a result, it is difficult to balance the design and the application of the thermal barrier coating. Therefore, it is very necessary to comprehensively evaluate the application effect of the thermal barrier coating in combination with the heat insulation performance and the stress level of the thermal barrier coating, and it is significant to establish a method to evaluate the comprehensive application effect of the thermal barrier coating on the turbine vane with respect to the application of the thermal barrier coating.

### SUMMARY

### I. Objects of the Present Invention

An object of the present invention is to provide a method for evaluating an application effect of a thermal barrier coating for a turbine vane on the basis of both heat insulation performance and a stress level of the thermal barrier coating.

### II. Technical Solutions

In order to solve the above problem, the present invention provides a method for evaluating an application effect of a thermal barrier coating for a turbine vane, the method comprising the following steps:

step 1, establishing a geometric model;

step 2, establishing a computational grid according to the geometric model;

step 3, setting a solution boundary condition and a material parameter according to the computational grid to perform iterative computation, so as to obtain distribution of temperature fields of two computational domains for the thermal barrier coating and the turbine vane;

step 4, setting a solution boundary condition and a material parameter according to the distribution of the temperature field of the computational domain for the thermal barrier coating and a computational grid for the thermal barrier coating to perform iterative computation, so as to obtain distribution of a stress field of the thermal barrier coating as well as maximum principal stress and maximum shear stress data of the stress field of the thermal barrier coating;

step 5, performing a preset program for calculation according to the distribution of the temperature fields of the two computational domains for the thermal barrier coating and the turbine vane as well as the maximum principal stress and maximum shear stress data of the stress field of the thermal barrier coating to obtain a heat insulation effect of the thermal barrier coating, so as to obtain a local comprehensive evaluation factor and a global comprehensive evaluation factor of the thermal barrier coating; and

step 6, evaluating the heat insulation effect and a stress level of the thermal barrier coating according to the local comprehensive evaluation factor and the global comprehensive evaluation factor of the thermal barrier coating.

Preferably, in step 1, finite element analysis software is adopted to establish a geometric model for the thermal barrier coating, a geometric model for the turbine vane and a geometric model for an external flow field, and the turbine vane is coated with and wrapped in the thermal barrier coating, wherein a geometric model material of the thermal barrier coating is set as yttria-stabilized zirconia, a geometric model material of the turbine vane is set as steel, and a geometric model material of the external flow field is set as air.

Preferably, in step 2, the computational grid comprises a computational grid for the thermal barrier coating, a computational grid for the turbine vane and a computational grid for the external flow field, wherein the computational grid for the thermal barrier coating is refined to obtain a temperature gradient and a stress gradient in the coating, refined at a fluid-solid interface where the computational grid is in contact with an air flow, and refined as a multi-layer boundary layer grid to reduce an error of convection heat transfer in calculation.

Preferably, in step 3, the computational grid for the thermal barrier coating, the computational grid for the turbine vane and the computational grid for the external flow field are imported into the finite element analysis software, the material parameter of the thermal barrier coating is defined, an SSTk-ω turbulence model and a non-equilibrium near wall model are adopted, and the solution boundary condition is set to perform iterative step solution until a result converges to be less than 10⁻⁵, so as to obtain the distribution of the temperature fields of the two computational domains for the thermal barrier coating and the turbine vane.

Preferably, the material parameter comprises a density, a heat transfer coefficient, a viscosity coefficient, a specific heat capacity and a thermal expansion coefficient; and the boundary condition comprises pressures and temperatures of both a main flow inlet and a main flow outlet, a pressure and a temperature of a cold air inlet, and a coupled heat transfer and periodic boundary condition of a wall.

Preferably, in step 4, the computational grid for the thermal barrier coating is imported into the finite element analysis software, the temperature field of the thermal barrier coating is assigned to the computational grid for the thermal barrier coating by interpolation, and the solution boundary condition and the material parameter are set to perform the iterative computation, so as to obtain the distribution of the stress field of the turbine vane having the thermal barrier coating as well as the maximum principal stress and maximum shear stress data of the stress field of the thermal barrier coating.

Preferably, in step 5, the heat insulation effect is expressed by a temperature difference between the thermal barrier coating and the turbine vane, and the temperature difference is obtained by subtracting a surface temperature at a corresponding location acquired in the temperature field of the computational domain of the thermal barrier coating from a surface temperature at a corresponding location acquired in the temperature field of the computational domain of the turbine vane.

Preferably, in step 5, formulas for the preset program of the local comprehensive evaluation factor and the global comprehensive evaluation factor of the thermal barrier coating are

$$Y = \frac{( {T}_{notbc} - {T}_{tbc} )}{{T}_{∞} - {T}_{c}} ( 1 - \frac{σ}{{σ}_{max}} ) , \\ and {Y}_{T} = \frac{{\int }_{S} \frac{( {T}_{notbc} - {T}_{tbc} )}{{T}_{∞} - {T}_{c}} ( 1 - \frac{σ}{{σ}_{max}} ) wdS}{S} ,$$

where Y is the local comprehensive evaluation factor of the thermal barrier coating, Y_{T} is the global comprehensive evaluation factor of the thermal barrier coating, S is a surface area of the vane, w is a danger coefficient, and is a value of dangerousness determined for different locations through a test, T_{tbc} is a surface temperature of the turbine vane having the thermal barrier coating, T_{notbc} is a surface temperature of the turbine vane without the thermal barrier coating, σₘₐₓ is a material strength of the thermal barrier coating, T_{∞} is a temperature of a gas inlet, T_{c} is a cooling gas temperature, and σ is the local maximum principal stress or maximum shear stress.

Preferably, in step 6, values of both the local comprehensive evaluation factor and the global comprehensive evaluation factor of the thermal barrier coating are less than 1; the smaller the values are, the worse the comprehensive performance of the thermal barrier coating is; and a negative value means that the coating stress is too large, resulting in failure of the coating.

### III. Beneficial Effects

Compared with the prior art, the present invention has the following beneficial effects. A simulation method of the thermal barrier coating for the three-dimensional turbine vane having an gas film hole is realized; and the evaluation parameters for the application effect of the thermal barrier coating are established, and the thermal barrier coating is evaluated while both heat insulation efficiency and a stress level are considered, so that the comprehensive application performance of the thermal barrier coating is reflected more comprehensively, which is more conducive to the design and the analysis of the thermal barrier coating.

In summary, by the method for evaluating the application effect of the thermal barrier coating provided by the present invention, the application and optimal design cost of the thermal barrier coating is greatly reduced, and good economic benefits are achieved.

### BRIEF DESCRIPTION OF THE DRAWINGS

FIG. 1 shows a schematic flow chart of an evaluation method provided by the present invention;

FIG. 2 is a geometric model for an external flow field;

FIG. 3 is a geometric model comprising a thermal barrier coating and a turbine vane;

FIG. 4 is cloud diagrams of temperatures on surfaces of the vane having the thermal barrier coating and the vane without the thermal barrier coating;

FIG. 5 is a line graph of heat insulation efficiency of the thermal barrier coating in an axial chord;

FIG. 6 is a line graph of a maximum principal stress of the thermal barrier coating on an external surface of the thermal barrier coating in the axial chord and a maximum principal stress of the thermal barrier coating on a contact surface between the turbine vane and the thermal barrier coating in the axial chord; and

FIG. 7 is a line graph of a comprehensive evaluation factor of the thermal barrier coating in the axial chord.

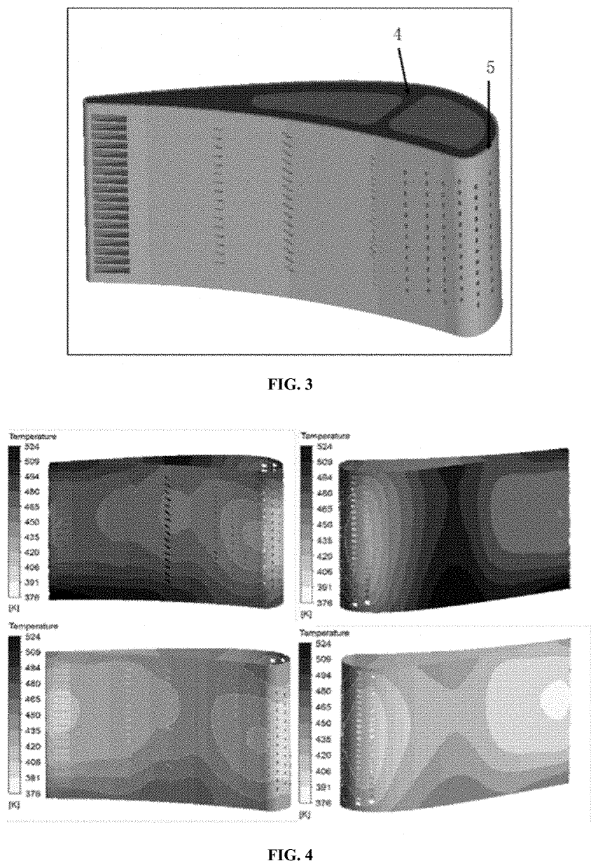

In FIG. 2, 1 is a gas inlet, 2 is a gas outlet, 3 is an external flow field, 4 in FIG. 3 is a turbine vane without a thermal barrier coating, and 5 in FIG. 3 is the thermal barrier coating.

### DETAILED DESCRIPTION

In order to make the objects, technical solutions and advantages of the present invention more apparently, the present invention is further described in detail below with reference to the specific embodiments and accompanying drawings. It should be understood that these descriptions are merely exemplary and are not intended to limit the scope of the present invention. In addition, in the following description, descriptions of well-known structures and techniques are omitted to avoid unnecessary obscuring of the concepts of the present invention.

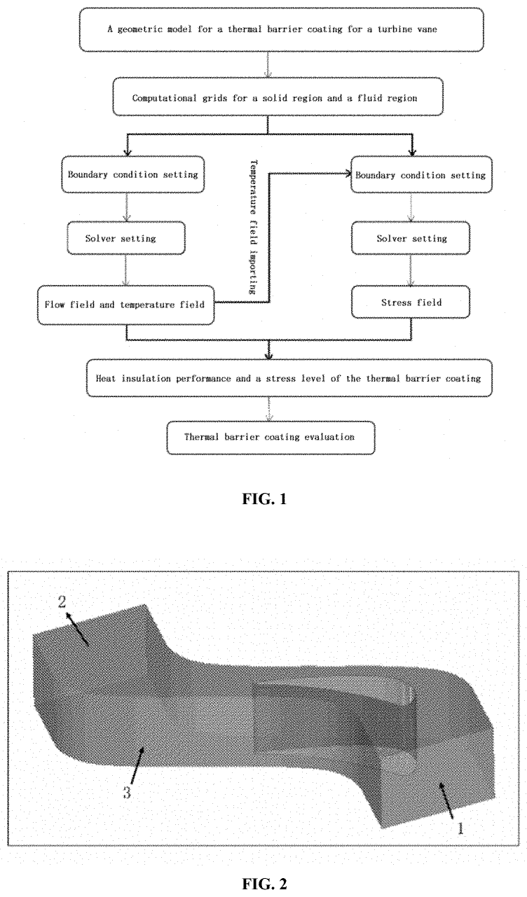

As shown in FIG. 1, the method for evaluating the application effect of the thermal barrier coating for the turbine vane provided by the present invention comprises the following steps.

In step 1, a geometric model for the thermal barrier coating, a geometric model for the turbine vane without the thermal barrier coating, and a geometric model for an external flow field are established in geometric modeling software.

In step 1.1, the geometric model for the external flow field as shown in FIG. 2 is established in Solidwork software, recorded as FLUID, and saved in an .x_t format.

In step 1.2, the geometric model for the thermal barrier coating and the geometric model for the turbine vane without the thermal barrier coating as shown in FIG. 3 are established in the Solidwork software. The geometric model for the thermal barrier coating is recorded as TBC and saved in the .x_t format. The geometric model for the turbine vane without the thermal barrier coating is recorded as VANE and saved in the .x_t format, wherein the thickness of the thermal barrier coating is 0.3 mm.

In step 1.3, a geometric model material of the thermal barrier coating is set as yttria-stabilized zirconia, a geometric model material of the turbine vane without the thermal barrier coating is set as steel, and a geometric model material of the external flow field is set as air.

In step 2, a computational grid for the thermal barrier coating, a computational grid for the turbine vane without the thermal barrier coating and a computational grid for the external flow field are established according to the geometric model for the thermal barrier coating, the geometric model for the turbine vane without the thermal barrier coating and the geometric model for the external flow field obtained in step 1.

In step 2.1, the geometric model for the thermal barrier coating, the geometric model for the turbine vane without the thermal barrier coating and the geometric model for the external flow field are imported into ICEM software to perform Boolean merge; and chamfering treatment and geometric repair are performed to enable a plane to be complete and continuous.

In step 2.2, grid parameters are set according to a geometric shape and size; the computational grid for the thermal barrier coating is refined; as the thickness of the thermal barrier coating is much smaller than the thickness of the turbine vane without the thermal barrier coating, in order to improve the grid quality, it is required to refine the grid for the thermal barrier coating; and the gird is refined at a fluid-solid interface into five boundary layers, the fluid-solid interface referring to an outer wall surface where the thermal barrier coating is in contact with an air flow.

In step 2.3, each of the computational grids is named correspondingly, wherein the computational grid for the thermal barrier coating is recorded as TBC; the geometric model for the turbine vane without the thermal barrier coating is recorded as VANE; the geometric model for the external flow field is recorded as FLUID; and an outlet and an inlet of each boundary, a vane surface and a periodic interface of each computational grid are named separately and are exported as a grid in a .cfx5 format, wherein a contact surface between the turbine vane and the thermal barrier coating is named as i-tbc, and an outer surface of the thermal barrier coating is named as s-tbc.

In step 3, material parameters of the thermal barrier coating are defined according to the computational grid for the thermal barrier coating, the computational grid for the turbine vane without the thermal barrier coating and the computational grid for the external flow field; and a solution boundary condition is set to perform iterative computation, so as to obtain distribution of temperature fields of two computational domains for the thermal barrier coating and the turbine vane without the thermal barrier coating.

In step 3.1, the three grid models in the .cfx5 format obtained in step 2 are imported into Ansys CFX software, and the grids are checked.

In step 3.2, it is defined that a material of the thermal barrier coating is set as yttria-stabilized zirconia, and parameters of the material as shown in Table 1 specifically comprise a density, a heat transfer coefficient, a viscosity coefficient, a specific heat capacity and a thermal expansion coefficient; a geometric model material of the turbine vane without the thermal barrier coating is set as steel; and a geometric model material of the external flow field is set as air. A shear stress transport turbulence model and a non-equilibrium near wall model are adopted; it is defined that a boundary condition comprises pressures and temperatures of both a main flow inlet and a main flow outlet, a pressure and a temperature of a cold air inlet, and a coupled heat transfer and periodic boundary condition of a wall, which are specifically shown in Table 2. 1200 iterative steps are set to solve, and a steady-state result is obtained after a result converges to be less than 10⁻⁵.

TABLE 1
Parameter Chart of Yttria-stabilized Zirconia

| | Elastic | | | Heat Transfer | Specific Heat | Thermal Expansion |
|---|---|---|---|---|---|---|
| | Modulus | Poisson's | Density | Coefficient | Capacity | Coefficient |
| Material | (GPa) | Ratio | (kg/m³) | (W/cm · K) | (J/Kg · K) | (10⁻⁶/° C.) |
| TBC | 22 | 0.12 | 4,930 | 1.02 × 10⁻² | 418 | 12 |

TABLE 2
Parameter Chart of Flow Field Boundary Condition

| Boundary | Boundary Condition |
|---|---|
| Main Flow Inlet | Total Temperature = 709 K, |
| | Total Pressure = 344,740 Pa, |
| | Turbulence Intensity = 5% |
| Main Flow Outlet | Static Pressure = 206,431 Pa |
| Inlet of Each of Front | Total Temperature = 339K, |
| and Rear Cooling | Total Pressure = 350,950 Pa, |
| Chambers | Turbulence Intensity = 5% |
| Periodic Boundary | Periodic Boundary Condition |

In step 3.3, after the calculation results in the previous step are analyzed and the convergence is confirmed, the distribution of the temperature fields of the computational domains for the thermal barrier coating and the turbine vane without the thermal barrier coating is exported and saved as a t_bc.csv file and a t_vane.csv file.

In step 4, a solution boundary condition and a material parameter are set according to the distribution of the temperature field of the computational domain for the thermal barrier coating and the computational grid for the thermal barrier coating to perform iterative computation, so as to obtain distribution of a stress field of the thermal barrier coating as well as maximum principal stress and maximum shear stress data of the stress field of the thermal barrier coating.

In step 4.1, the computational grid for the thermal barrier coating is imported into Ansys finite element analysis software, and the temperature field of the thermal barrier coating obtained in the previous step is imported into the grid by interpolation.

In step 4.2, a linear elastic solution model is set, wherein thermal stress is considered; and it is defined that material parameters comprise the density, elastic modulus, Poisson's ratio, heat transfer coefficient and specific heat capacity; and the boundary condition is set for solution calculation.

In step 4.3, after the calculation results in the previous step are analyzed and the convergence is confirmed, the maximum principal stress and the maximum shear stress of the stress field of the thermal barrier coating are exported; and the exported data are saved as a Stress_principal.csv file and a Stress_shear.csv file.

In step 5, a preset calculation program is performed for calculation according to the distribution of the temperature fields of the two computational domains for the thermal barrier coating and the turbine vane without the thermal barrier coating as well as the maximum principal stress and maximum shear stress data of the stress field of the thermal barrier coating to obtain heat insulation efficiency of the thermal barrier coating, so as to obtain a local comprehensive evaluation factor and a global comprehensive evaluation factor of the thermal barrier coating.

In step 5.1, surface temperatures at corresponding locations in the temperature fields of the two computational domains for the thermal barrier coating and the turbine vane without the thermal barrier coating are extracted, and are subjected to subtraction to obtain heat insulation performance of the thermal barrier coating.

In step 5.2, data of both the Stress_principal.csv file and the Stress_shear.csv file are extracted to obtain the maximum principal stress and the maximum shear stress at the interface of the thermal barrier coating.

In step 5.3, the following Y as an evaluation factor of the thermal barrier coating is established; the heat insulation efficiency and the maximum principal stress of the thermal barrier coating are input; and a self-programmed Python program is adopted to calculate the local comprehensive evaluation factor and the global comprehensive evaluation factor of the thermal barrier coating, wherein the calculation formulas are as follows:

$$\begin{matrix}Y = \frac{( {T}_{notbc} - {T}_{tbc} )}{{T}_{∞} - {T}_{c}} ( 1 - \frac{σ}{{σ}_{max}} ) , & ( 1 ) \\ and {Y}_{T} = \frac{{\int }_{S} \frac{( {T}_{notbc} - {T}_{tbc} )}{{T}_{∞} - {T}_{c}} ( 1 - \frac{σ}{{σ}_{max}} ) wdS}{S} . & ( 2 )\end{matrix}$$

Y is the local comprehensive evaluation factor of the thermal barrier coating; Y_{T} is T the global comprehensive evaluation factor of the thermal barrier coating; S is a surface area of the vane; and w is a danger coefficient, and is a value of dangerousness determined for different locations through a test. Here, considering a curvature of each of a leading edge and a trailing edge and severe erosion of the vane, a function as shown in FIG. 4 is selected experientially. T_{tbc} is a surface temperature of the turbine vane having the thermal barrier coating; T_{notbc} is a surface temperature of the turbine vane without the thermal barrier coating; σₘₐₓ is a material strength of the thermal barrier coating; T_{∞} is a temperature of a gas inlet; T_{c} is a cooling gas temperature; and σ is the local maximum principal stress or maximum shear stress.

The obtained local and global comprehensive evaluation factors of the thermal barrier coating simultaneously reflect both the heat insulation effect and the stress level of the thermal barrier coating. It is of great significance for the design and optimization of the thermal barrier coating by using a value of the comprehensive evaluation factor to evaluate the comprehensive performance of the thermal barrier coating. The obtained value is less than 1. The larger the value is, the better the heat insulation effect is; the lower the stress level is, the higher the comprehensive evaluation is; and the smaller the value is, the worse the comprehensive evaluation is. When the value is negative, it means that the coating partially peels off.

A value of the danger coefficient win the formula is obtained by the following formula:

w(xₛ,z)=1−b[|sin(πz)cos(2πxₛ)|+sin(πz)cos(2πxₛ)] (3).

In the formula, b is a danger factor, z is a vane height, and xₛ is a chord length location of the vane, and is determined by an experiment. As dangers at different locations in engineering are different, in order to obtain an overall evaluation factor, it is required to multiply a basic evaluation Y by a weigh w, wherein w needs to take different values according to engineering practices, w in the vane under different working conditions is different, and the value of w in the formula 3 is given experimentally according to an experiment.

FIG. 4 is cloud diagrams of temperatures on surfaces of the vane having the thermal barrier coating and the vane without the thermal barrier coating. By comparison of FIGS. 4 (a) and 4(b) as well as 4(c) and 4(d), it can be found that the thermal barrier coating significantly reduces the temperature of the vane and the temperature gradient of the vane.

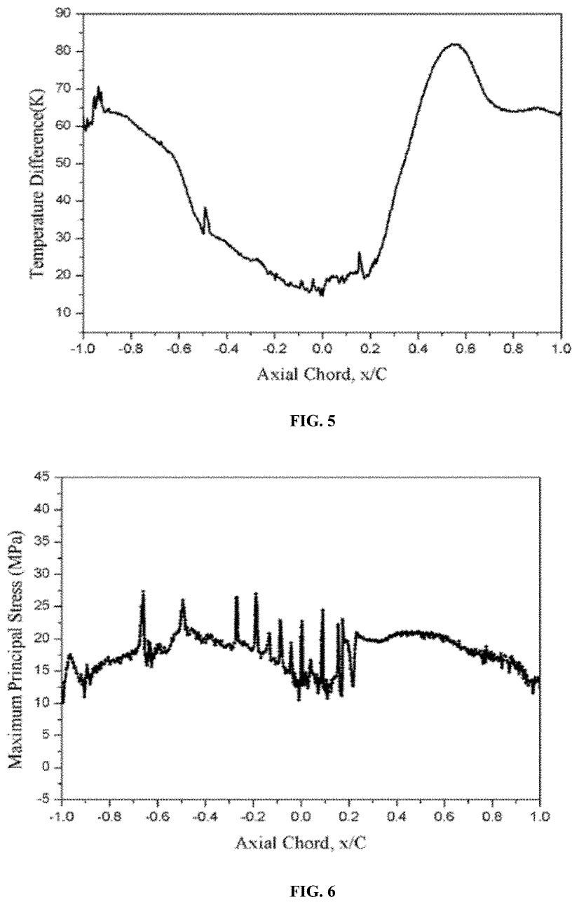

FIG. 5 is a line graph of heat insulation efficiency of the thermal barrier coating in an axial chord. In FIG. 5, the abscissa (from −1 to 1) indicates chordwise relative locations from the trailing edge, a pressure surface, the leading edge, a suction surface to the trailing edge. It can be seen that the heat insulation efficiency of the thermal barrier coating at the leading edge and the pressure surface is relatively lower, and is about 20 K; and the heat insulation efficiency at the trailing edge is basically higher than 60 K.

FIG. 6 is a line graph of a maximum principal stress of the thermal barrier coating on an external surface of the thermal barrier coating in the axial chord and a maximum principal stress of the thermal barrier coating on a contact surface between the turbine vane and the thermal barrier coating in the axial chord. It can be seen that the maximum principal stress of the thermal barrier coating on the contact surface between the turbine vane and the thermal barrier coating in the axial chord is greater than the maximum principal stress of the thermal barrier coating on the external surface of the thermal barrier coating in the axial chord; and the stress at the gas film hole is higher.

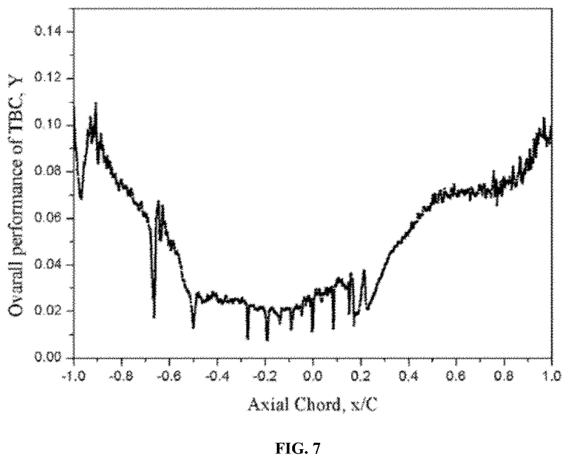

FIG. 7 is a line graph of a comprehensive evaluation factor of the thermal barrier coating in the axial chord. In combination with formula (1), it can be seen from the figure that a, Y of the thermal barrier coating at the leading edge and a space around the same is smaller, which is caused by bad comprehensive performance of the thermal barrier coating at the leading edge arising from the poorer heat insulation performance and the higher thermal stress of the thermal barrier coating at the leading edge; b, the comprehensive performance of the thermal barrier coating at the trailing edge is good as the thermal barrier coating has excellent heat insulation efficiency and a lower stress at the trailing edge; and c, the comprehensive performance of the thermal barrier coating in the middle of the pressure surface is not the highest as in the middle of the pressure surface, although the heat insulation efficiency is the highest, the stress level is higher. It can also be obtained that when b=0.5, Yt=0.01684, which may be a parameter for comparing overall application effects of different thermal barrier coatings, facilitating the optimal design of the thermal barrier coatings in engineering. Therefore, in the evaluation method provided by the present invention, the evaluation value of the comprehensive performance of the thermal barrier coating can be obtained while both the heat insulation performance and the stress level of the thermal barrier coating are considered, which is of great significance for the design and the optimization of the thermal barrier coating.

In the present example, the heat insulation performance and the heat stress of the thermal barrier coating for the turbine vane are solved, so that the comprehensive performance of the thermal barrier coating can be evaluated while both the heat insulation performance and the stress level of the thermal barrier coating are considered. An actual working condition of a turbine engine is much more complex than this condition herein. It is of great significance for the design and the optimization of the thermal barrier coating in engineering by using the method provided by the present invention to simulate and evaluate the thermal barrier coating in a more complex environment.

1. A method for evaluating an application effect of a thermal barrier coating for a turbine vane, the method comprising the following steps:
step 1, establishing a geometric model;
step 2, establishing a computational grid according to the geometric model;
step 3, setting a solution boundary condition and a material parameter according to the computational grid to perform iterative computation so as to obtain distribution of temperature fields of two computational domains for the thermal barrier coating and the turbine vane;
step 4, setting a solution boundary condition and a material parameter according to the distribution of the temperature field of the computational domain for the thermal barrier coating and a computational grid for the thermal barrier coating to perform iterative computation, so as to obtain distribution of a stress field of the thermal barrier coating as well as maximum principal stress and maximum shear stress data of the stress field of the thermal barrier coating;
step 5, performing a preset calculation program for calculation according to the distribution of the temperature fields of the two computational domains for the thermal barrier coating and the turbine vane as well as the maximum principal stress and maximum shear stress data of the stress field of the thermal barrier coating to obtain a heat insulation effect of the thermal barrier coating, so as to obtain a local comprehensive evaluation factor and a global comprehensive evaluation factor of the thermal barrier coating; and
step 6, evaluating the heat insulation effect and a stress level of the thermal barrier coating according to the local comprehensive evaluation factor and the global comprehensive evaluation factor of the thermal barrier coating.

2. The method for evaluating the application effect of the thermal barrier coating for the turbine vane according to claim 1, wherein in step 1, finite element analysis software is adopted to establish a geometric model for the thermal barrier coating, a geometric model for the turbine vane and a geometric model for an external flow field, and the turbine vane is coated with and wrapped in the thermal barrier coating, wherein a geometric model material of the thermal barrier coating is set as yttria-stabilized zirconia, a geometric model material of the turbine vane is set as steel, and a geometric model material of the external flow field is set as air.

3. The method for evaluating the application effect of the thermal barrier coating for the turbine vane according to claim 1, wherein in step 2, the computational grid comprises a computational grid for the thermal barrier coating, a computational grid for the turbine vane and a computational grid for the external flow field, wherein the computational grid for the thermal barrier coating is refined to obtain a temperature gradient and a stress gradient in the coating, refined at a fluid-solid interface where the computational grid is in contact with an air flow, and refined as a multi-layer boundary layer grid to reduce an error of convection heat transfer in calculation.

4. The method for evaluating the application effect of the thermal barrier coating for the turbine vane according to claim 1, wherein in step 3, the computational grid for the thermal barrier coating, the computational grid for the turbine vane and the computational grid for the external flow field are imported into the finite element analysis software, the material parameter of the thermal barrier coating is defined, an SSTk-ω turbulence model and a non-equilibrium near wall model are adopted, and the solution boundary condition is set to perform iterative step solution until a result converges to be less than 10⁻⁵, so as to obtain the distribution of the temperature fields of the two computational domains for the thermal barrier coating and the turbine vane.

5. The method for evaluating the application effect of the thermal barrier coating for the turbine vane according to claim 4, wherein the material parameter comprises a density, a heat transfer coefficient, a viscosity coefficient, a specific heat capacity and a thermal expansion coefficient; and the boundary condition comprises pressures and temperatures of both a main flow inlet and a main flow outlet, a pressure and a temperature of a cold air inlet, and a coupled heat transfer and periodic boundary condition of a wall.

6. The method for evaluating the application effect of the thermal barrier coating for the turbine vane according to claim 1, wherein in step 4, the computational grid for the thermal barrier coating is imported into the finite element analysis software, the temperature fields of the thermal barrier coating and the turbine vane are assigned to computational grids of the two computational domains by interpolation, and the solution boundary condition and the material parameter are set to perform the iterative computation, so as to obtain the distribution of the stress field of the turbine vane having the thermal barrier coating as well as the maximum principal stress and maximum shear stress data of the stress field of the thermal barrier coating.

7. The method for evaluating the application effect of the thermal barrier coating for the turbine vane according to claim 1, wherein in step 5, the heat insulation effect is expressed by a temperature difference between the thermal barrier coating and the turbine vane, and the temperature difference is obtained by subtracting a local surface temperature acquired in the temperature field of the computational domain of the thermal barrier coating from a local surface temperature acquired in the temperature field of the computational domain of the turbine vane.

8. The method for evaluating the application effect of the thermal barrier coating for the turbine vane according to claim 1, wherein in step 5, formulas for the preset calculation program of the local comprehensive evaluation factor and the global comprehensive evaluation factor of the thermal barrier coating are
$$Y = \frac{( {T}_{notbc} - {T}_{tbc} )}{{T}_{∞} - {T}_{c}} ( 1 - \frac{σ}{{σ}_{max}} ) , \\ and {Y}_{T} = \frac{{\int }_{S} \frac{( {T}_{notbc} - {T}_{tbc} )}{{T}_{∞} - {T}_{c}} ( 1 - \frac{σ}{{σ}_{max}} ) wdS}{S} ,$$
wherein Y is the local comprehensive evaluation factor of the thermal barrier coating, Y_{T} is the global comprehensive evaluation factor of the thermal barrier coating, S is a surface area of the vane, w is a danger coefficient, and is a value of dangerousness determined for different locations through a test, T_{tbc} is a surface temperature of the turbine vane having the thermal barrier coating, T_{notbc} is a surface temperature of the turbine vane without the thermal barrier coating, σₘₐₓ is a material strength of the thermal barrier coating, T_{∞} is a temperature of a gas inlet, T_{c} is a cooling gas temperature, and σ is the local maximum principal stress or maximum shear stress.

9. The method for evaluating the application effect of the thermal barrier coating for the turbine vane according to claim 1, wherein in step 6, the local comprehensive evaluation factor of the thermal barrier coating is less than 1; the smaller the local comprehensive evaluation factor is, the worse the comprehensive performance of the thermal barrier coating is; and a negative value of the local comprehensive evaluation factor means that the coating stress is too large, resulting in failure of the coating.
